(19) United States
(12) Patent Application Publication
(10) Pub. No.: US 2013/0082941 A1
(43) Pub. Date: Apr. 4, 2013

(54) WRIST-WORN DEVICE AND PARAMETER ADJUSTING METHOD USING THEREOF

(71) Applicants: YING-XIONG HUANG, Tu-Cheng (TW); YING-CHUAN YU, Tu-Cheng (TW)

(72) Inventors: YING-XIONG HUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 13/303,168

(22) Filed: Nov. 23, 2011

(30) Foreign Application Priority Data
Sep. 29, 2011 (TW) 100135128

(51) Int. Cl. G06F 3/041

(52) U.S. Cl. 345/173

(57) ABSTRACT

An exemplary adjusting method is implemented by a wrist-worn device. The wrist-worn device is capable of working in several modes. The wrist-worn device includes a case, a display, and a touch sensitive unit. The touch sensitive unit is fixed to the case. The method includes: monitoring touches on the touch sensitive unit, and switch from a current working mode to another working mode in a cycle if the touches are recognized after comparison with stored touches.

### BACKGROUND

1. Technical Field

The present disclosure relates to wrist-worn devices and parameter adjusting methods implemented by the wrist-worn device and, particularly, to a wrist-worn device capable of user-friendly adjustment and parameter adjusting method implemented by the wrist-worn device.

2. Description of Related Art

Many wrist-worn devices offer a high number of functions, such as displaying data, the time, an alarm and others. The functions are generally accessible to the user by actuating one, two or several push buttons placed on the case body to activate the different operating modes corresponding to the functions. However, after long period of use, the buttons may not operate reliably. Although a wrist-worn device with a touch sensitive unit covering the display unit is in existence, the display unit is usually small, which may result in accidental activation of an operating mode.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a wrist-worn device in accordance with an exemplary embodiment.

FIG. 2 is a flowchart of a parameter adjusting method implemented by the wrist-worn device of FIG. 1 in accordance with an exemplary embodiment.

### DETAILED DESCRIPTION

The embodiments of the present disclosure are described in detail, with reference to the accompanying drawings.

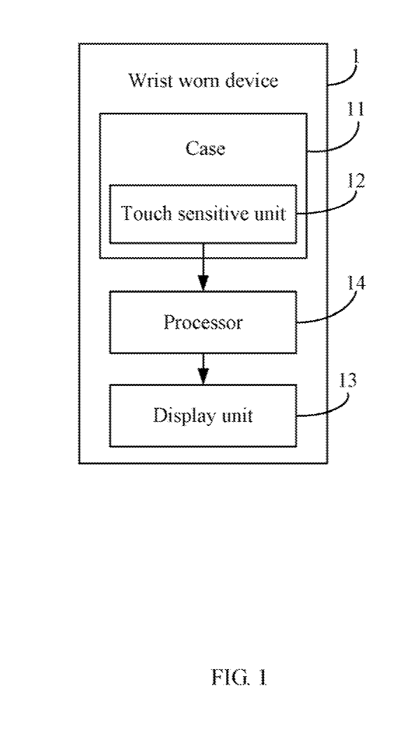

Referring to FIG. 1, a block diagram of a wrist-worn device 1 in accordance with an exemplary embodiment is shown. The wrist-worn device 1 includes a case 11, a touch sensitive unit 12, a display 13, and a processor 14. The components of the wrist-worn device 1 are received in the case 11.

The wrist-worn device 1 can operate in at least four work modes. In the embodiment, the four work modes include a normal mode, a time mode, a date mode, and a volume mode. Any of these work modes may be selected. In the normal mode, the processor 14 controls the display unit 13 to simultaneously display current time, current date, and current volume level. In the time mode, the processor 14 controls the display unit 13 to only display current time. In the date mode, the processor 14 controls the display unit 13 to only display current date. In the volume mode, the processor 14 controls the display unit 13 to only display current volume level.

In an alternative embodiment, in each of the four work modes, the processor 14 may control the display unit 13 to simultaneously display the current time, current date, and current volume, with only the display element appropriate to that mode highlighted, thus the processor 14 highlights the current time in the time mode, highlights the current date in the date mode, and highlights the volume level in the volume mode.

The wrist-worn device 1 normally operates in the normal mode. The current time is displayed in three parameters, indicating “hours” data, “minutes” data, and “seconds” data. The current date is also displayed in three parameters, indicating “year” data, “month” data, and “date” data. The processor 14 can switch a current working mode to another, can select a particular parameter in a current working mode, and adjust the value of the selected parameter in response to a user operation.

In the embodiment, when a switching command is received, the processor 14 determines the current working mode and the working mode next to the current work mode and then switches the mode to that next mode. The current working mode and the next working mode are preset. For example, the four working modes may be configured to apply in the order of normal mode, then time mode, then date mode, then volume mode, and then back to the starting mode. The processor 14 can determine the working mode next to the current working mode according to the configured order. Similarly, the parameters indicating hour, minute, second in the time mode may be ordered for adjustment in the order of hours, then minutes, and then seconds, and the parameters indicating year, month, and date, may be ordered for adjustment in that order. The processor 14 selects a parameter next to the current selected parameter according to the configured order.

The touch sensitive unit 12 is fixed to the case 11. The display 13 is fixed to the top surface of the case 11.

The processor 14 can monitor the period of time for which a user touches the touch sensitive unit 12. If the time period is less than a first predetermined value, such as 5 seconds, the processor 14 determines that the operation is a mistake and takes no action. If the time period is equal to or more than the predetermined value, the processor 14 determines that the touch represents a switching command and switches the current working mode to the next one.

In an alternative embodiment, the processor 14 can monitor the number of separate touches that a user carries out on the touch sensitive unit 12 within a first predetermined time. If the number of touches is less than a predetermined number, such as 2, the processor 14 may determine that the operation is a mistake and take no action. If the number of touches is equal to or more than a predetermined number, the processor 14 determines that the number of touches represents a switching command and switches the current working mode to the next one.

When the wrist-worn device 1 is operating in any of the modes, the processor 14 can further determine the point(s) of touch on the touch sensitive unit 12, and can determine the track of any moving touches (touch track) based on the point(s) of touch. When the touch track matches a stored first track, the processor 14 determines that the operation is a selection command and selects a default parameter in the current mode. When a second or further touch track is determined, the processor 14 selects the parameter next to the current selection. A selected parameter is adjustable. Only one parameter can be selected in the volume mode. When the touch track matches a stored second track, the processor 14 determines that the operation represents an adjustment command and may adjust the value of the selected parameter. In the embodiment, the first track is constituted by a left/right direction of movement, and the second track is constituted by an up/down direction of movement.

In the embodiment, if the second track is established by a vertical touch track, a down-to-up direction of movement will gradually increase the value of the selected parameter. If the established touch track is made in an up-to-down direction of movement, the processor 14 will gradually decrease the parameter value of the selected parameter.

In the embodiment, the processor 14 further controls the display unit 13 to illuminate or display the currently-adjustable parameter at a predetermined frequency to inform the user, and further controls the display unit 13 to stop illuminating or displaying the currently-adjustable parameter when the processor 14 monitors that the touch sensitive unit 12 has not been touched within a second predetermined period of time, and to regard the currently-displayed value of the parameter as the desired value.

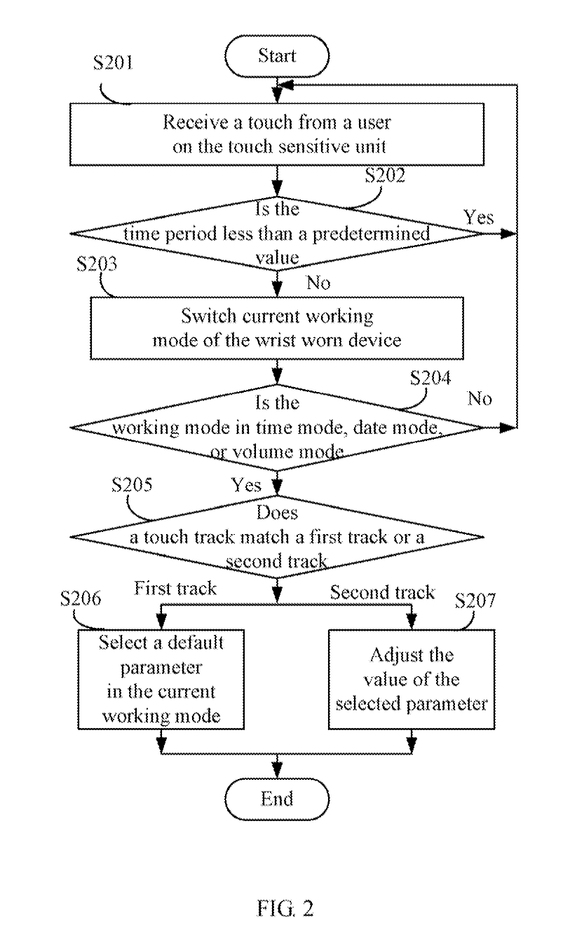

Referring to FIG. 2, a parameter adjusting method in accordance with an exemplary embodiment is shown.

In step S201, the processor 14 receives a touch from a user on the touch sensitive unit 12.

In step S202, the processor 14 monitors the time period that the user is touching the touch sensitive unit 12. If the time period is less than a predetermined value, the procedure goes back to step S201. If the time period is equal to or more than a predetermined value, the procedure goes to step S203.

In step S203, the processor 14 switches the current working mode of the wrist-worn device 1 to the next working mode.

In step S204, the processor 14 monitors the current mode of operation of the wrist-worn device. If the wrist-worn device is operating in the time mode, the date mode, or the volume mode, the procedure goes back to step S205. While the wrist-worn device is operating in the default or normal mode, the procedure remains in step S201.

In step S205, the processor 14 determines the point(s) of touch carried out on the touch sensitive unit 12 to determine one or more touch track(s), and determines whether any touch track matches a stored first track or a stored second track. If the touch track does match the first track, the procedure goes to step S206. If a touch track match the stored second track, the procedure goes to step S207.

In step S206, the processor 14 selects a default parameter in the current working mode.

In step S207, the processor 14 adjusts the value of the selected parameter according to user input, as represented by the general and particular direction(s) of movement of the finger or the stylus of the user.

In an alternative embodiment, the processor 14 monitors the number of times that the user touches the touch sensitive unit 12 within a first predetermined period of time. When the number of touches is equal to or more than a predetermined number, the processor 14 switches the current working mode of the wrist-worn device 1 to the next one in the cycle. When the number of touches is less than the predetermined number, the processor 14 determines that the operation is a mistake and takes no action.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A wrist-worn device capable of working in a plurality of working modes, the wrist-worn device comprising:
a case;
a display;
a touch sensitive unit fixed to the case; and
a processor configured to monitor a period of time or number of separate touches that a user carries out on the touch sensitive unit, and to switch a current working mode of the wrist-worn device to the next one if the period of time or number of separate touches equals to or exceeds a preset value, and the processor being configured to determine the point(s) of touch on the touch sensitive unit to determine the track of any moving touches, wherein if the track of any moving touches matches a stored first track, the processor selects a default parameter in the current work mode, and if the touch track matches a stored second track, the processor adjusts a value of the selected parameter.

2. The wrist-worn device as described in claim 1, wherein the processor further controls the display unit to illuminate or display the currently adjustable parameter at a predetermined frequency to inform the user.

3. The wrist-worn device as described in claim 4, wherein the processor further controls the display unit to stop illuminating or displaying the currently-adjustable parameter when the processor determines that the touch sensitive unit has not been touched within a second predetermined period of time, and to regard the currently-displayed value of the parameter as the desired value.

4. The wrist-worn device as described in claim 1, wherein the plurality of working modes comprise a normal mode, a time mode, a date mode, and a volume mode, the display simultaneously displays current time, current date, and current volume level in the normal mode, displays current time in the time mode, displays current date in the date mode, and displays current volume level in the volume mode.

5. The wrist-worn device as described in claim 1, wherein the plurality of working modes comprises a normal mode, a time mode, a date mode, and a volume mode, the processor controls the display to simultaneously displays current time, current date and current volume level in each of the four work modes, and respectively highlights current time in the time mode, highlights current date in the date mode, and highlights current volume level in the volume mode.

6. A parameter adjusting method implemented by a wrist-worn device, the wrist-worn device capable of working in a plurality of working modes, the wrist-worn device comprising a case, a display, and a touch sensitive unit, the touch sensitive unit being fixed to the case, the method comprising:
monitoring a period of time or number of separate touches that a user carries out on the touch sensitive unit, and to switch current working mode to the next one if the period of time or number of separate touches equals to or exceeds a preset value;
determining the point(s) of touch on the touch sensitive unit to determine the track of any moving touches;
selecting a default parameter in the current work mode when the track of any moving touches matching a stored first track; and
adjusting a value of the selected parameter when the track of any moving touches matching a stored second track.

7. The parameter adjusting method as described in claim 6, wherein the method further comprises:
controlling the display unit to illuminate or display the currently adjustable parameter at a predetermined frequency to inform the user.

8. The parameter adjusting method as described in claim 7, wherein the method further comprises:
controlling the display unit to stop illuminating or displaying the currently-adjustable parameter when the processor determines that the touch sensitive unit has not been touched within a second predetermined period of time, and to regard the currently-displayed value of the parameter as the desired value.

9. The parameter adjusting method as described in claim 6, the plurality of working modes comprising a normal mode, a time mode, a date mode, and a volume mode, wherein the method further comprises:
controlling the display to display the current time, current date, and current volume level in the normal mode, only displaying current time in the time mode, displaying current date in the date mode, and displaying current volume level in the volume mode.

10. The parameter adjusting method as described in claim 6, the plurality of working modes comprising a normal mode, a time mode, a date mode, and a volume mode, wherein the method further comprises:
controlling the display to display current time, current date and current volume level in each of the four work modes, and respectively highlighting current time in the time mode, highlighting current date in the date mode, and highlighting current volume level in the volume mode.
